(19) United States
(12) Patent Application Publication
(10) Pub. No.: US 2014/0314555 A1
(43) Pub. Date: Oct. 23, 2014

(54) SYSTEM, METHOD AND APPARATUS FOR VERTICAL AXIS WIND TURBINES WITH LAMINAR FLOW

(71) Applicant: Dan Welch, Maricopa, AZ (US)

(72) Inventor: Dan Welch, Maricopa, AZ (US)

(21) Appl. No.: 14/210,370

(22) Filed: Mar. 13, 2014

Related U.S. Application Data
(60) Provisional application No. 61/785,776, filed on Mar. 14, 2013.

(51) Int. Cl. F03D 1/06

(52) U.S. Cl. CPC F03D 1/0608
USPC 415/185

(57) ABSTRACT

A vertical axis wind turbine having a plurality of air foils arranged along the periphery of a rotor and moveable with the wind. The air foils configured to capture wind energy from the front of the wind turbine and upon exit. Wind diverters, interior and exterior to the wind turbine, accelerate air flows and minimize turbulences.

### RELATED PATENT APPLICATION

The present application is a non-provisional of U.S. Provisional Patent Application Ser. No. 61/785,776, the disclosure of which is incorporated herein by reference.

### BACKGROUND OF THE INVENTION

The capture of wind power and the translation of that power into other, usable forms of energy have been a long-time human endeavor. From ancient windmills to the giant wind farms of today, the efficient capture and harnessing of this renewable energy is of paramount importance to modern economies. With the growing need for cleaner and greener energies, the importance of advances in cleaner alternative energy production is manifest.

Wind turbines harness the kinetic energy of the wind and convert it into mechanical or electric power. Traditional wind turbines have a horizontal spinning axis that allow blades of the wind turbine to rotate around the axis, capturing the ambient wind. As wind engages the turbine blades, the blades move around the horizontal spinning axis of the wind turbine. The relative rotation of the blades to the horizontal axis may then be converted into mechanical and electrical energy.

Recently, vertical axis wind turbines have been used to harness the kinetic energy of the wind. Vertical axis wind turbines operate in the same manner as horizontal axis wind turbines; however, the axis is a vertical plane and the blades spin around the vertical axis. Conventional wind turbines receive air flows across both the upwind and downwind sides of the wind turbine, which creates turbulence around and through the device, due to inefficient and inadequate control of the wind.

There is, therefore, a need to maximize the efficiency of the wind air flows passing through a wind turbine, capturing more energies from the wind.

There is, therefore, a concomitant need to minimize turbulence associated with air flows passing through a turbine.

### SUMMARY

The present invention is directed to techniques, systems, apparatuses and methods to increase the efficiency of a wind turbine or like apparatus by increasing the capture of energy of wind flows passing through a wind turbine, particularly a vertical axis wind turbine, and minimizing the turbulence of those air flows.

In the instant invention, the rotating airfoils on the rotor provide two lifting surfaces, one at the leading edge of the wind flow and the other at the trailing edge of the wind flow passing through. Stators or wind diverters, placed inside the rotor, accelerate the air flows making it past the blades, and straightening those air flows, where the airfoils on the backside of the rotor recover the previously-lost energies of the exiting wind, usually the cause of turbulence. In like fashion, the stators, when placed to block the air flows, stop the turbine rotation without a mechanical brake. Further, outside wind diverters likewise channel and accelerate the incoming air flows across the inlet throat of the turbine, while creating minimal backpressure.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements, in which:

FIG. 1 is a front, generally elevation view of a wind turbine configuration pursuant to a first embodiment of the present invention, with a number of airfoils and a pair of interior or internal stators or wind diverters inside the periphery of the airfoils;

FIG. 2 is a top view of the wind turbine configuration shown in FIG. 1;

FIG. 3 is a front, generally elevation view of a wind turbine configuration pursuant to a second embodiment of the present invention, which includes another pair of exterior or external stators or wind diverters outside the periphery of the airfoils; and

FIG. 4 is a schematic view of components generally shown in FIGS. 1-3.

### DETAILED DESCRIPTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

As discussed, there is an ever-increasing need for clean and green energy sources. The harnessing and capture of wind energies has been a facet of human endeavor for many centuries. The instant invention and the substantial advantages thereof offer a further advancement in this field.

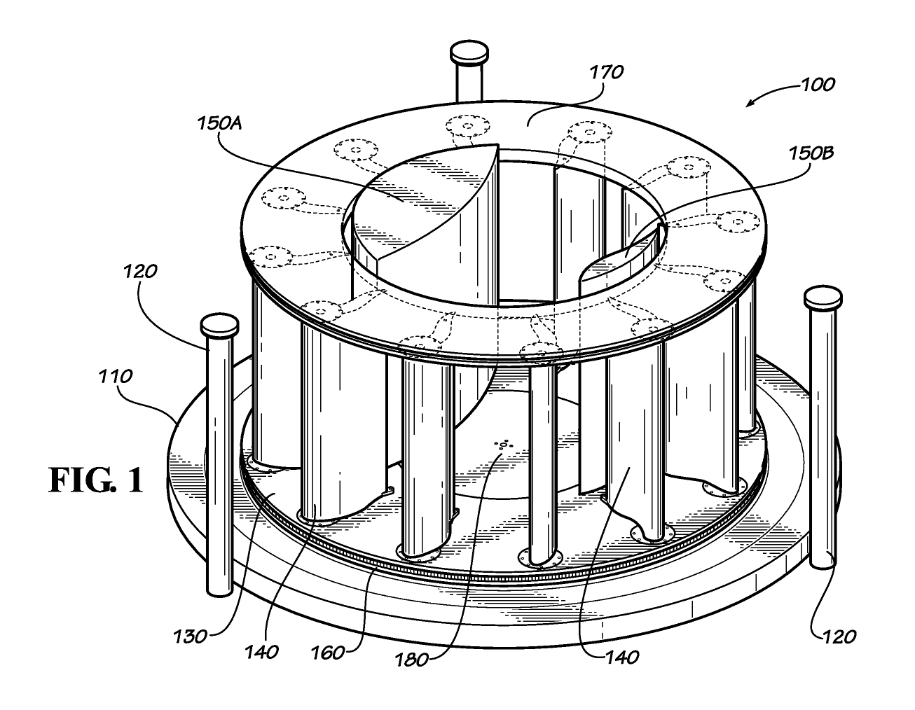

With reference now to FIG. 1 of the DRAWINGS, there is illustrated therein an elevational, generally front view of a wind turbine that employs and implements the principles of the present invention. For example, such wind turbines are described in more detail in U.S. patent application Ser. Nos. 12/215,232, 12/215,233, now U.S. Pat. No. 8,513,826, Ser. No. 13/607,167, now U.S. Pat. No. 8,608,425, Ser. No. 13/607,270, now U.S. Pat. No. 8,608,426, Ser. Nos. 14/107,922, and 14/107,951, each cited as background to the instant invention, where the subject matters of each of said applications are incorporated herein by reference.

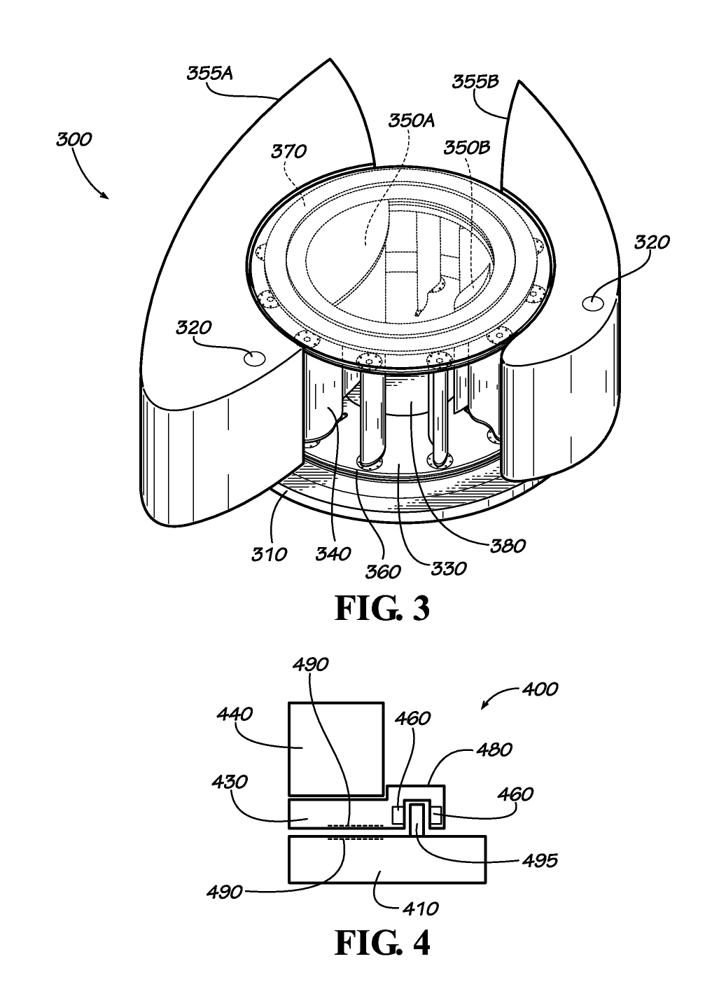

Shown in FIG. 1 is a representative configuration of a wind turbine according to the present invention, generally designated by the reference numeral 100. As illustrated, the wind turbine 100 is a vertical axis wind turbine pursuant to a first embodiment of the present invention. A stator base plate 110 and various support beams, generally designated by the reference numeral 120, which are used in connection with the embodiment set forth in FIG. 3, are illustrated. Atop the stator base plate 110 is a base rotor 130, which may employ magnetic levitation, as set forth and described in the aforementioned related cases, incorporated herein by reference. It should, nonetheless, be understood that non-magnetic levitation configurations are also contemplated in this (and the other) embodiments.

Affixed along the circumferential surface of the base rotor 130, preferably along the periphery, as illustrated, are a number of equally-spaced and configurable air foils, generally designated by the reference numeral 140, aligned in a vertical configuration about the rotor 130, which rotates pursuant to the presence of wind along with the plurality of airfoils affixed thereto along the periphery thereof. As is understood in the art, air flows entering the illustrated wind turbine 100 pass through the air foils 140, providing lift or energy to the leading edge surfaces of the various air foils 140, as they encounter the incoming air flows, i.e., as the air foils 140 rotate with the rotor 130 into the ambient wind.

As is shown in FIG. 1, the air flows passing through the wind turbine 100 from the front of the drawing to the other side encounter the opposing air foils 140 along the circumference or periphery, as described and illustrated, where the trailing edges of those airfoils 140 have a “leading” edge portion (e.g., a reflex blade) that contacts the through-flowing air, and captures further kinetic energy from the wind. In this fashion, the present invention attains further lift or rotational speed from the exiting wind off the leading-edge-portion of the trailing edges of those opposing air foils 140, which thus acquire additional torque and additional coefficient of lift. In this manner, the air foil 140 configuration of the present invention achieves a double lift effect, capturing further energies from the dissipating, exiting wind flows.

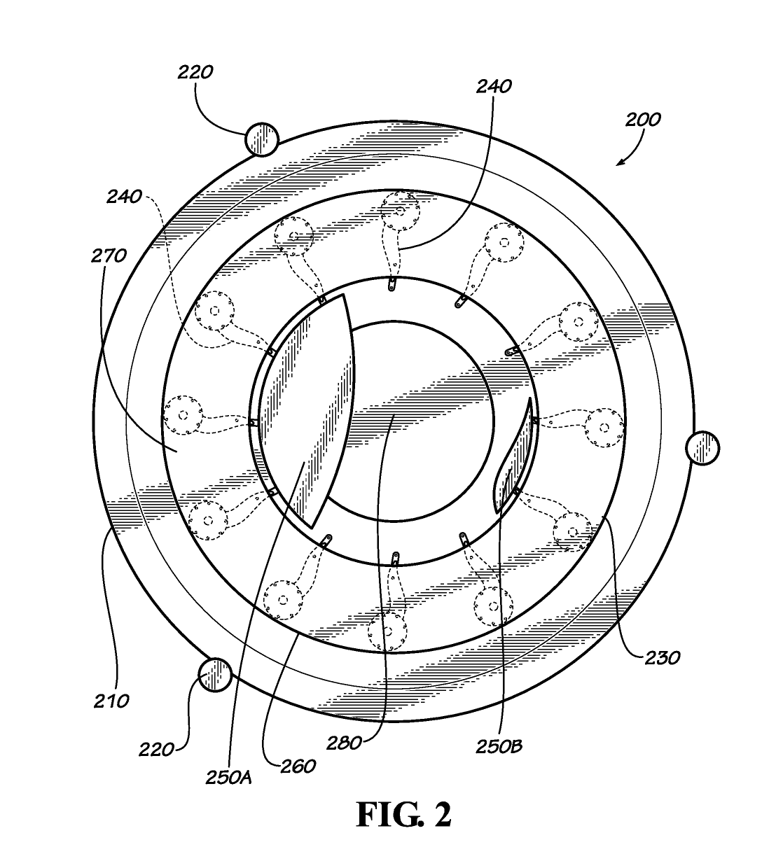

With further reference to FIG. 1, there are shown interior wind diverters 150, which primarily act as stators. A large and a small wind diverter, generally designated by the reference identifiers 150A and 150B, respectively, are shown, both contoured to better govern, control and accelerate the incoming air flows passing through the air foils 140 into straightened laminar flows, facilitating the aforementioned backside, opposing air foil lift, as described hereinabove. The larger interior stator 150A preferably has one side in conformity with the circular curvature inside the air foil 140 circle, i.e., a generally circular curve is described for this first vertical surface of stator 150A, and the other side or surface is preferably configured in a generally concave shape to redirect the incoming air flows, as described and illustrated. Likewise, the smaller interior stator 150B preferably has one side curved along the air foil 140 circle, as described, with a generally circular curve shape, and the other surface in a generally concave shape (when viewed from above) with a larger portion of the concave abutting the incoming air flows and the other side trailing off. Further illustration of the above is found in FIG. 2 of the DRAWINGS, where the second surface of the smaller interior stator 150B has a more streamlined surface with a leading portion or edge to capture the wind and narrower trailing portion to straighten the wind, as described.

It should be understood that the aforementioned shapes of the wind diverters 150A and 150B are such that they both accelerate and laminarize the incoming air flows, but Applicant has discovered that these shapes also govern and minimize turbulence as well, which is a serious problem with prior art stators. By so controlling the interior air flows through the wind turbine 100, the aforementioned double energy capture is made possible, and several problems of devices without such diverters are solved as well. For example, in operation, the rotating air foils 140 produce a chopping noise, which is a byproduct of harmonics, and produce other effects due to the turbulence of the air flowing therethrough, which are alleviated or eliminated by the configuration of the present invention.

With further reference to FIG. 1, there is generally shown a modular linear synchronous generator 160, and a top rotor plate 170, to which the aforementioned air foils 140 are affixed at their other end. Also shown is an air or magnetic bearing, generally designated by the reference numeral 180, allowing the rotational movement of the rotors. As discussed, in a preferred embodiment of the present invention, a levitation magnetic array is also employed, as discussed further and illustrated hereinbelow. As discussed, non-magnetic levitation systems incorporating the instant inventions are envisioned. The more detailed configuration of these components is shown in FIG. 4, discussed in more detail hereinbelow.

With reference now to FIG. 2, this is a top view of the wind turbine 100 illustrated in FIG. 1. As discussed, wind turbine 200 in this figure further illustrates the configuration and contours of the interior wind diverters, and better illustrates the laminar air flow and recapture described hereinabove, resulting from the improvements of the instant invention. As illustrated, wind flow enters from the bottom of the figure and encounters the air foils 240, rotating about a base rotor, generally designated by the reference numeral 230, channeling the air into the interior portion of the turbine 200, as shown. A large wind diverter 250A and a smaller wind diverter 250B further control, govern or laminarize the air flow, reducing turbulence, as discussed. A number of support beams 220 are disposed about the turbine 200, and the rotor base 230 and rotor top plate 270, with the air foils disposed therebetween, rotate about an air or magnetic bearing, generally designated by the reference numeral 280, as described hereinabove in connection with FIG. 1.

With reference now to FIG. 3 of the DRAWINGS, there is shown another embodiment of the present invention, a wind turbine 300 that employs further wind capture measures than those depicted in FIGS. 1 and 2. In particular, there are illustrated two exterior wind diverters, a larger and a smaller one, generally designated by the reference identifiers 355A and 355B, respectively, which also act as stators, secured by the aforementioned support beams, generally designated by the reference numeral 320 to the turbine, generally designated by the reference numeral 300.

As is clear from the figure, air flows entering through the front of the illustrated wind turbine 300 in FIG. 3 are augmented by the exterior wind diverters 355A and 355B channeling, controlling and accelerating air flows and winds into a wind turbine configuration, such as those described above in connection with FIGS. 1 and 2. In particular, the outside wind diverters 355A and 355B accelerate air flows across the inlet throat of the turbine, while also quelling backpres sure and turbulence, as described hereinabove, e.g., moving the unused nearby wind away from the turbine 300 structure in smooth air flows, minimizing turbulence and the potential for structural damage. In this manner, further laminar flows can be attained to drive air foils 340 faster and with less turbulence, thereby achieving increased efficiencies of operation.

As the size of the interior and exterior wind diverters 350A, 350B, 355A and 355B can be quite large, the diverters are preferably made of sail or cloth material, with an underlying framework to support the aerodynamic configurations and lessen the weight. It should, nonetheless, be understood that the diverters can be made of a variety of materials, including wood and metal also. As is understood in the art, the various interior and exterior wind diverters are configurable either manually to various fixed positions, or are preferably dynamically and automatically configurable to track and harness the power of the ambient winds.

As discussed, the various related patent applications are incorporated by reference. As also discussed, a preferred embodiment of the present invention employs magnetic levitation techniques to reduce friction and further increase energy capture. With reference to FIG. 4 of the DRAWINGS, an exemplary representative configuration of a levitation magnetic array, generally designated by the reference numeral 490, with magnets disposed in opposition, is illustrated, in connection with components of the instant invention for clarity. As shown, some of the magnets are disposed in a base rotor 430, which oppose magnets disposed in a stator base plate 410. In operation, the magnets reduce or eliminate the frictional forces between the stator 410 and rotor 430, allowing the apparatus 400 to rotate frictionless, with a number of air foils 440 capturing wind, as described, and rotating about a bearing 480 atop a stator 495. Also shown is a modular linear synchronous generator 460. Further details about the operation and configuration of these levitation magnets are set forth in the related patent applications incorporated herein by reference in their entirety.

Preferred methods and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

1. A vertical axis wind turbine comprising:
a circular rotor;
a plurality of airfoils affixed to said rotor and disposed along the circular periphery of said rotor, said rotor and airfoils rotating with the wind; and
at least one interior wind diverter, said wind diverter positioned on said rotor inside the configuration of said plurality of airfoils, said at least one wind diverter having a first curved surface substantially circular facing a number of said airfoils, and a second curved surface, opposite said first curve surface and substantially concave

2. The vertical axis wind turbine according to claim 1, further comprising:
a second rotor, said second rotor configured above said circular rotor and each of said airfoils being affixed to said second rotor along the periphery thereof.

3. The vertical axis wind turbine according to claim 1, wherein said at least one interior wind diverter is configurable to harness the wind power.

4. The vertical axis wind turbine according to claim 3, wherein said at least one interior wind turbine is manually configurable.

5. The vertical axis wind turbine according to claim 4, wherein said at least one interior wind turbine is manually configurable to a plurality of fixed positions.

6. The vertical axis wind turbine according to claim 3, wherein said at least one interior wind turbine is automatically configurable.

7. The vertical axis wind turbine according to claim 6, wherein said at least one interior wind turbine is automatically and dynamically configurable with a wind tracker to orient said at least one interior wind diverter to the ambient wind.

8. The vertical axis wind turbine according to claim 1, further comprising:
a second interior wind diverter, said second interior wind diverter being disposed opposite said at least one interior wind diverter inside the configuration of said plurality of airfoils.

9. The vertical axis wind turbine according to claim 8, wherein said second interior wind diverter has a first curved surface substantially circular facing a number of said airfoils, and a second curved surface, opposite said first curved surface and substantially concave.

10. The vertical axis wind turbine according to claim 8, wherein said second interior wind diverter has a first curved surface substantially circular facing a number of said airfoils, and a second curved surface, opposite said first curved surface, said second surface having a streamlined curve shape.

11. The vertical axis wind turbine according to claim 1, further comprising:
at least one exterior wind diverter, said wind diverter positioned exterior to and along said rotor and said plurality of airfoils, said at least one exterior wind diverter having a first curved surface substantially circular facing a number of said airfoils.

12. The vertical axis wind turbine according to claim 11, wherein said at least one exterior wind diverter is configurable to harness the wind power.

13. The vertical axis wind turbine according to claim 12, wherein said at least one exterior wind turbine is manually configurable.

14. The vertical axis wind turbine according to claim 13, wherein said at least one exterior wind turbine is manually configurable to a plurality of fixed positions.

15. The vertical axis wind turbine according to claim 12, wherein said at least one exterior wind turbine is automatically configurable.

16. The vertical axis wind turbine according to claim 15, wherein said at least one exterior wind turbine is automatically and dynamically configurable with a wind tracker to orient said at least one exterior wind diverter to the ambient wind..

17. The vertical axis wind turbine according to claim 11, further comprising:
a second exterior wind diverter, said second wind diverter positioned generally opposite to said at least one exterior wind diverter, and exterior to and along said rotor and said plurality of airfoils, said second exterior wind diverter having a first curved surface substantially circular facing a number of said airfoils.

18. The vertical axis wind turbine according to claim 11, further comprising:
a plurality of support beams to affix said at least one exterior wind diverter to said wind turbine.

19. The vertical axis wind turbine according to claim 1, wherein said at least one wind diverter is adjustable, said at least one wind diverter being adjustable to stop air flow through said wind turbine.

20. The vertical axis wind turbine according to claim 1, further comprising:
a stator base plate, said circular rotor positioned atop said stator base plate and rotatable thereon.

21. The vertical axis wind turbine according to claim 1, wherein said plurality of airfoils have a reflex blade.

22. The vertical axis wind turbine according to claim 1, wherein said plurality of airfoils and said at least one wind diverter are composed of a material selected from the group consisting of cloth, sail, wood, metal and combinations thereof.

23. The vertical axis wind turbine according to claim 1, further comprising:
at least one levitating magnet, said at least one levitating magnet system in operation lifting said circular rotor.

24. A vertical axis wind turbine comprising:
a circular rotor;
a plurality of airfoils affixed to said rotor and disposed along the circular periphery of said rotor, said rotor and airfoils rotating with the wind; and
at least one exterior wind diverter, said wind diverter positioned exterior to and along said rotor and said plurality of airfoils, said at least one exterior wind diverter having a first curved surface substantially circular facing a number of said airfoils.

25. The vertical axis wind turbine according to claim 24, wherein said at least one exterior wind diverter is configurable to harness the wind power.

26. The vertical axis wind turbine according to claim 24, further comprising:
a second exterior wind diverter, said second wind diverter positioned generally opposite to said at least one exterior wind diverter, and exterior to and along said rotor and said plurality of airfoils, said second exterior wind diverter having a first curved surface substantially circular facing a number of said airfoils.
